(19) United States
(12) Patent Application Publication
(10) Pub. No.: US 2025/0330681 A1
(43) Pub. Date: Oct. 23, 2025

(54) INTERACTION METHOD, APPARATUS, DEVICE AND STORAGE MEDIUM

(71) Applicant: Beijing Youzhuju Network Technology Co., Ltd., Beijing (CN)

(72) Inventors: Ling Zhu, Beijing (CN); Tianbao Jiao, Beijing (CN)

(21) Appl. No.: 18/968,215

(22) Filed: Dec. 4, 2024

(30) Foreign Application Priority Data
Apr. 22, 2024 (CN) 202410488042.8

(51) Int. Cl. H04N 21/4722; H04N 21/254

(52) U.S. Cl. CPC H04N 21/4722; H04N 21/2542

(57) ABSTRACT

The embodiments of the disclosure relate to an interaction method, apparatus, device and a storage medium. The method provided herein includes: in response to a correlation between a content presentation page and a target virtual resource being greater than a threshold, displaying, in the content presentation page, resource information corresponding to the target virtual resource, the correlation being determined based on a target object in a first object set corresponding to the content presentation page, and the target object being an object matching the target virtual resource; and displaying a second object set matching the target virtual resource based on a predetermined operation on the resource information. In this way, the embodiments of the disclosure can dynamically provide the resource information related to the related virtual resource according to the information of the object corresponding to the content presentation page, thereby improving the efficiency of obtaining the information by users.

### CROSS-REFERENCE TO RELATED APPLICATION

This application claims the priority of Chinese Patent Application No. 202410488042.8, filed on Apr. 22, 2024, entitled “Interaction Method, Apparatus, Device and Storage Medium”, the entire content of which is incorporated herein by reference.

### FIELD

Example embodiments of the present disclosure generally relate to the field of computers, and in particular, to an interaction method, apparatus, device and storage medium.

### BACKGROUND

In recent years, with the rapid development of the Internet, the Internet has become an important platform for people to obtain various types of information. For example, a user may utilize the Internet to search for various types of objects, or to view various types of objects.

### SUMMARY

In a first aspect of the present disclosure, an interaction method is provided. The method comprises the following steps: in response to a correlation between a content presentation page and a target virtual resource being greater than a threshold, displaying, in the content presentation page, resource information corresponding to the target virtual resource, the correlation being determined based on a target object in a first object set corresponding to the content presentation page, and the target object being an object matching the target virtual resource; and displaying a second object set matching the target virtual resource based on a predetermined operation on the resource information.

In a second aspect of the present disclosure, an apparatus for interaction is provided. The apparatus comprises: a first display module, configured to, in response to a correlation between a content presentation page and a target virtual resource being greater than a threshold, display, in the content presentation page, resource information corresponding to the target virtual resource, the correlation being determined based on a target object in a first object set corresponding to the content presentation page, and the target object being an object matching the target virtual resource; and a second display module, configured to display a second object set matching the target virtual resource based on a predetermined operation on the resource information.

In a third aspect of the present disclosure, an electronic device is provided. The device comprises at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIG. 2A to FIG. 2C illustrate example interfaces in accordance with some embodiments of the present disclosure;

FIG. 3 shows a flowchart of an example interaction process according to some embodiments of the present disclosure;

FIG. 4 illustrates a schematic structural block diagram of an example apparatus for interaction according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data is collected, obtained, processed, manufactured, forwarded, used, etc., all of which are performed on the premise that the user knows and confirms. Accordingly, when implementing the embodiments of the present disclosure, the types, the usage scope, the usage scenario, and the like of the data or information that may be involved, should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, the processing may be performed on the premise of having a legality basis (for example, obtaining consent of a personal information subject, or necessary for performing a fulfillment contract), and processing only within a specified or agreed range. The user rejects personal information other than necessary information required by the basic function, and does not affect the basic function of the user.

As mentioned above, the Internet is an important tool for people to search for objects and view objects. For example, people may utilize Internet applications to search for specific types of objects (e.g., commodity). How to effectively provide relevant information when presenting related objects to people is a focus.

The embodiment of the invention provides an interaction scheme. According to the solution, in response to a correlation between a content presentation page and a target virtual resource being greater than a threshold, display, in the content presentation page, resource information corresponding to the target virtual resource, the correlation being determined based on a target object in a first object set corresponding to the content presentation page, and the target object being an object matching the target virtual resource. Further, a second object set matching the target virtual resource may be displayed based on a predetermined operation on the resource information.

In this way, the embodiments of the present disclosure can dynamically provide the resource information related to the related virtual resource according to the information of the object corresponding to the content presentation page, thereby improving the efficiency of obtaining the information by the user.

Various example implementations of this scheme are described in detail below in conjunction with the accompanying drawings.

### Example Environment

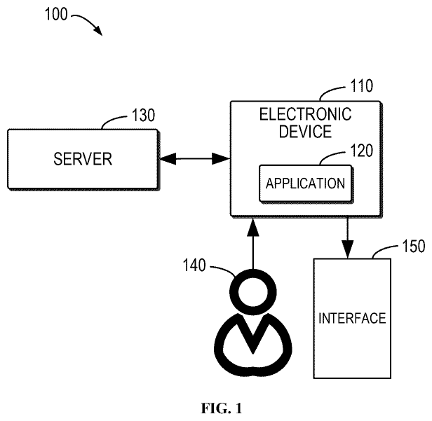

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to, search applications, e-commerce applications, or other suitable applications available for presentation of content. The user 140 may interact with the application 120 via the electronic device 110 and/or its attachment device.

In the environment 100 of FIG. 1, if the application 120 is active, the electronic device 110 may present, via the application 120, an interface 150 for supporting interface interaction.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Interaction

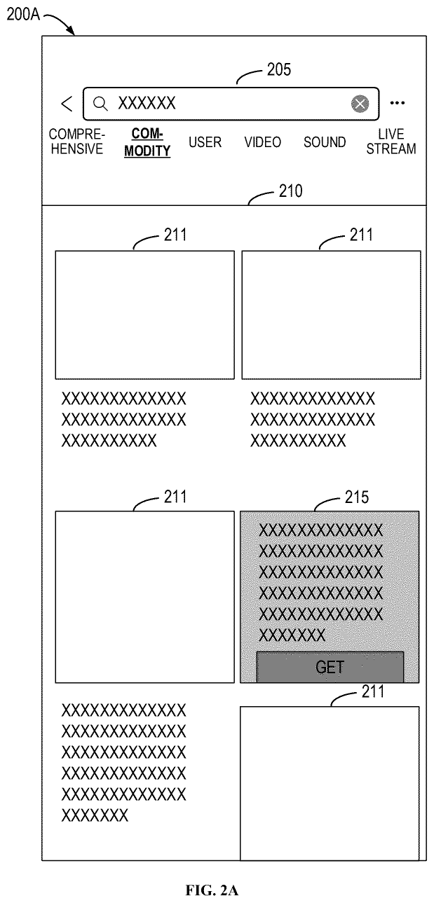

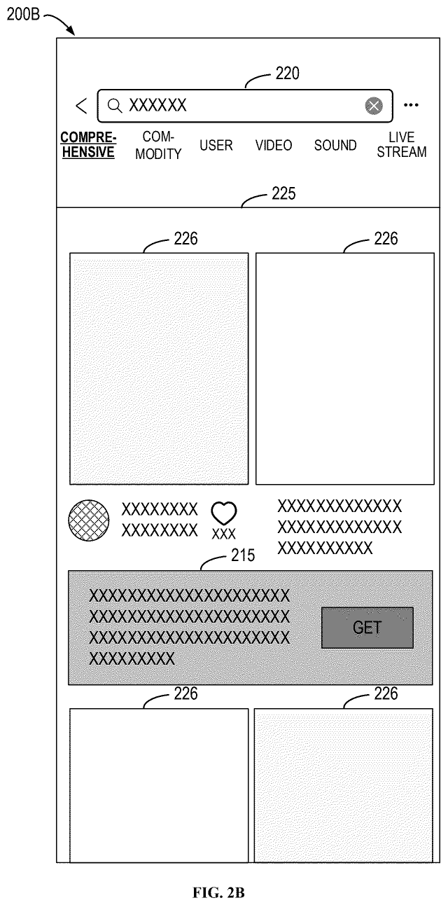

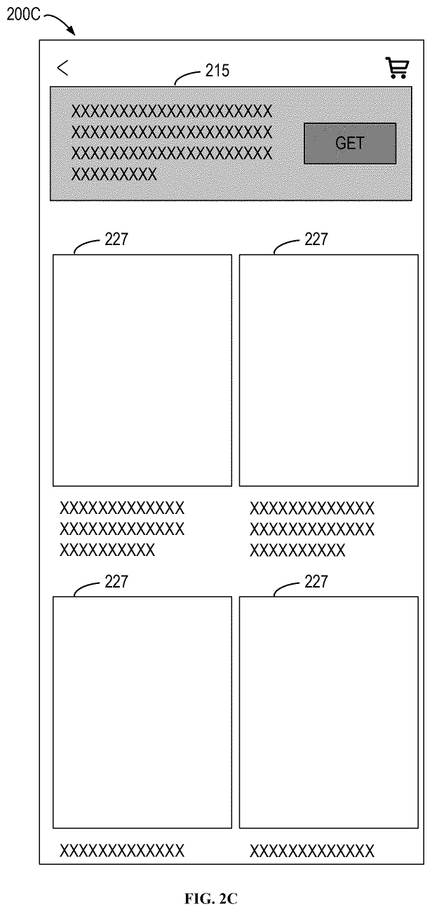

FIGS. 2A-2C illustrate example interfaces 200A-200C, in accordance with some embodiments of the present disclosure. The interface 200A to the interface 200C may be provided, for example, by the electronic device 110 shown in FIG. 1.

In some embodiments, the electronic device 110 may present the content presentation page 210 as shown in the content interface 200A of FIG. 2A in the aforementioned application 120.

In some embodiments, the electronic device 110 may display the resource information 215 corresponding to the target virtual resource in the content presentation page 210 in response to the correlation between the content presentation page 210 and the target virtual resource being higher than a threshold. The correlation is determined based on a target object in a first object set corresponding to the content presentation page 210, and the target object is an object matching the target virtual resource. In some embodiments, “the target object is an object matching the target virtual resource” is intended to indicate whether the object cannot use the corresponding target virtual resource.

As an example, the electronic device 110 may present a first object set in the content presentation page 210, the first object set may include a plurality of objects, and the object may be any suitable object such as a commodity or a content item.

In some embodiments, the content presentation page 210 may include any suitable interface for presenting an object. For example, the content presentation page 210 may be an interface presented based on a user's viewing request; or a search interface presented based on a user's search request; or may be an interface automatically presented by the application 140.

In some embodiments, the target virtual resource that matches the target object is intended to represent any suitable type of virtual resource that the target object may use. Taking the target object being a commodity as an example, such a virtual resource may include, for example, a virtual coupon that may be used in association with the commodity object. As another example, the target object may be, for example, a content item, and correspondingly, such a virtual resource may include, for example, a virtual promotion resource that may be used in association with the content item object.

In some embodiments, the target object includes a commodity category, and the target virtual resource indicates a virtual benefit associated with the commodity object. As an example, the virtual benefit may include discount benefit regarding commodity objects, etc.

In some embodiments, such virtual resources may also indicate virtual benefit associated with the target object. For example, such a virtual benefit may include a discounted benefit regarding the commodity object, a promotional benefit about the content item object, a download benefit about the photo object, and the like.

For ease of description, embodiments of the present disclosure are described below by taking commodities as examples of objects.

In some embodiments, the resource information 215 corresponding to the target virtual resource may be one or more interaction components, the plurality of interaction components may be associated with different types of target virtual resources, and one interaction component may be associated with one or more target virtual resources of the same category.

In some embodiments, the electronic device 110 may receive a search request of a user, and present the content presentation page 210 shown in FIG. 2A in the foregoing application 120. The first object set is a plurality of objects presented in the content presentation page 210 in association with the search request. As an example, such a search request may be associated with any suitable type of search item, examples of which may include, but are not limited to: text search item, image search item, audio search item, video search item, and the like.

In some embodiments, the electronic device 110 may determine that the search request matches a particular type of object (e.g., a commodity object) in response to the search request being obtained via a dedicated search portal corresponding to a particular type of search result. As an example, if the search request is obtained through the commodity search portal, the plurality of objects in the first object set presented by the content presentation page corresponding to the search request are all commodity objects. If the search request is obtained through the video search portal, the plurality of objects in the first object set presented by the corresponding content presentation page are all video objects.

In some embodiments, referring to FIG. 2A, the electronic device 110 provides a commodity search portal 205 in the search interface 200A of FIG. 2A. Further, the electronic device 110 may receive the search request of the user based on the commodity search portal 205, and present the content presentation page 210 associated with the search request. The electronic device 110 may present, in the content presentation page 210, a plurality of objects 211 associated with the search request, and the plurality of objects 211 are all commodity objects.

It should be understood that the particular type is intended to characterize the type of search result determined based on the search request (i.e., the first object set presented by the content presentation page 210). For example, the returned search results may include different types of search results, such as news, videos, pictures, commodity, content items, and the like.

In some embodiments, the content presentation page 210 includes a an object list associated with the search request, and the first object set is a predetermined number of objects that are preferentially presented in the object list. It may be understood that the content presentation page 210 presents objects (which may also be referred to as a search result) in the form of a list in the form of a list. As an example, if the predetermined number is 20, the plurality of objects in the first object set are 20 objects preferentially presented in the object list.

In some embodiments, the electronic device 110 may respond to the search request obtained via a comprehensive search portal corresponding to a plurality of types of search results, it may be understood that, in the comprehensive search portal, the search request may correspond to a plurality of types of search results. As an example, in the comprehensive search portal, the search request may be a search result of a type such as a commodity type, a video type, and a music type.

In some embodiments, referring to FIG. 2B, the electronic device 110 provides a comprehensive search portal 220 in the content interface 200B of FIG. 2B. Further, the electronic device 110 may receive the search request of the user based on the comprehensive search portal 220, and present the comprehensive content presentation page 225 associated with the search request. The electronic device 110 may present a plurality of objects 226 associated with the search request in the comprehensive content presentation page 225, and the plurality of objects 226 may correspond to different types. Further, the electronic device 110 may provide resource information 215 in comprehensive content presentation page 225 for obtaining and/or using virtual resources.

In some embodiments, the electronic device 110 may determine one or more categories matching the query item based on the query item included in the search request. As an example, if the query item is a dress, the electronic device 110 may determine that the corresponding category is clothes. In some embodiments, the electronic device 110 may also determine a multi-level category matching the query item, e.g., clothes-women's clothes-dress.

In some embodiments, the electronic device 110 may determine a candidate virtual resource set corresponding to the category, and determine the target virtual resource from the candidate resource set. As an example, the candidate virtual resource set corresponding to the category may include a plurality of candidate virtual resources associated with the category.

Taking the categories including clothes, women's clothes and dress as examples, the electronic device 110 may determine candidate virtual resources applicable for clothes, candidate virtual resources applicable to women's clothes, and candidate virtual resources applicable to the dress, and further determine the candidate virtual resource set.

In some embodiments, the electronic device 110 may determine a correlation between the content presentation page 210 and the candidate virtual resource set (that is, a plurality of correlations between the content presentation page 210 and the plurality of candidate resources in the candidate virtual set). Further, the electronic device 110 may use the candidate virtual resource whose correlation with the content presentation page 210 is higher than the threshold from the candidate virtual resource set as the target virtual resource.

In some embodiments, the electronic device 110 may, in response to correlations between the content presentation page 210 and a plurality of candidate virtual resources being all greater than the threshold, determine, from the plurality of candidate virtual resources with correlations all higher than a threshold, the target virtual resource based on at least one attribute of the plurality of candidate virtual resources. It may be understood that, when the correlation between the plurality of candidate virtual resources and the content presentation page 210 is greater than the threshold, the target virtual resource needs to be determined from the plurality of candidate virtual resources according to at least one attribute. As an example, the plurality of candidate virtual resources may be a plurality of virtual coupons, and the at least one attribute may indicate, for example, information such as a usage limit and a usage effect of the virtual coupons.

In some embodiments, the electronic device 110 may determine a number of objects in the first object set that matches the corresponding virtual resource. It should be understood that the corresponding virtual resource may represent any candidate virtual resource in the target virtual resource or the candidate virtual resource set.

That is, the correlation between the content presentation page and the target virtual resource may be determined based on the number of objects in the first object set that match the target virtual resource. The correlation between the content presentation page and the candidate virtual resource may be determined based on the number of objects in the first object set that match the candidate virtual resource.

Specifically, each virtual resource may be used by at least one object, and an object matching the corresponding virtual resource is an object that may use a corresponding virtual resource. As an example, the number of objects in the first object set that match the corresponding virtual resource may be: the number of objects in the first object set that match the virtual resource A is m (m may refer to any number), and the number of objects that match the virtual resource B (different from the virtual resource A) in the first object set is n (n may refer to any number).

In some embodiments, further, the electronic device 110 may determine the correlation between the content presentation page 210 and the corresponding virtual resource based on the number. Therefore, when the correlation between only one corresponding virtual resource and the content presentation page 210 is higher than the threshold, the corresponding virtual object may be referred to as the target virtual resource. When the correlation between the plurality of corresponding virtual resources and the content presentation page 210 is greater than the threshold, a corresponding virtual resource may be determined from the plurality of corresponding virtual resources as the target virtual resource based on the at least one attribute. As an example, the correlation between the content presentation page 210 and the corresponding virtual resource corresponding to the number 2 may be 20%, and the correlation between the content presentation page 210 and the corresponding virtual resource corresponding to the number 4 may be 40%. It may be understood that the correspondence between the number and the correlation is merely an example description, and the correspondence relationship between the number and the correlation may be set by a relevant person skilled in the art based on needs. However, it is clear that the higher the number, the higher the correlation between the content presentation page 210 and the corresponding virtual resource.

In some embodiments, the electronic device 110 may determine whether the content presentation page 210 includes an object. It may be understood that the object herein may refer to a specific type of object, for example, the object is a commodity object, and the electronic device 110 may determine whether the content presentation page 210 includes a commodity object.

In some embodiments, the electronic device 110 may determine that the content presentation page 210 includes the commodity object in response to determining that the commodity object is included at the predetermined position in the content presentation page 210. That is, the electronic device 110 may detect an object presented at a predetermined position in the content presentation page 210. If the object is a commodity object, it may be determined that the content presentation page 210 includes a commodity object.

In some embodiments, the electronic device 110 may determine whether the correlation between the content presentation page 210 and the target virtual resource is higher than a threshold in response to the content presentation page 210 including the object. As an example, in a scenario where the electronic device 110 determines that the content presentation page 210 includes a specific object, it may be determined, based on the foregoing method for calculating the correlation, whether there is a target virtual resource whose correlation with the content presentation page 210 is higher than a threshold.

In some embodiments, the electronic device 110 may display the resource information 215 at a target position in the content presentation page 210, where the target position is determined based on the reference position of the reference object in the content presentation page 210. As an example, the reference object is an object applicable for the target virtual resource or an object displayed at the predetermined position. The display position in the content presentation page 210 where the reference object is located is the reference position.

In some embodiments, the distance between the target position and the reference position may be a predetermined distance. As an example, the relevant technician may set the predetermined distance to be 5, and the target position displayed in the content presentation page 210 is the 5th position after the reference position.

In some embodiments, the distance between the target position and the reference position may be associated with the target virtual resource. It may be understood that the distance between the target position and the reference position may be adjusted according to different target virtual resources. As an example, if the target virtual resource is the virtual resource A, the distance between the target position and the reference position may be set as the distance A, and if the target virtual resource is the virtual resource B, the distance between the target position and the reference position may be set as the distance B, and the specific value setting of the distance A or the distance B may be set by the relevant technician according to needs, which is not limited in the present disclosure.

In some embodiments, the electronic device 110 may further display description information of the at least one object in the content presentation page 210, where the description information may indicate whether the at least one object matches the target virtual resource. It can be understood that the description information of the object is displayed in the content presentation page 210, and the user can be helped to quickly know whether the object (for example, the commodity) can use the target virtual resource (for example, a virtual coupon).

In some embodiments, the aforementioned resource information 215 is the first resource information 215, and the electronic device 110 may further display, in the content presentation page 210, second resource information corresponding to a further virtual resource based on a predetermined operation on the content presentation page 210.

In some embodiments, the predetermined operation may comprise: a first operation for refreshing the content presentation page 210. As an example, the electronic device 110 may present the second resource information in the new content presentation page 210 based on the user's request to refresh the search result.

In some embodiments, the relevant technician may set the predetermined number of times of refreshing, and the electronic device 110 may present the second resource information in the content presentation page 210 in response to the number of times of refreshing reaching the predetermined number of times of refreshing. As an example, if the predetermined number of times of refreshing is 3, in the previous two searching processes, the electronic device 110 maintains presenting the first resource information in the content presentation page 210, and in the 3rd searching process, the second resource information is presented.

In some embodiments, the predetermined operation may comprise: a second operation for sliding the content presentation page to view an additional search result. As an example, the electronic device 110 may present the additional search result (e.g., the second object set) and the second resource information in the content presentation page 210 based on the sliding operation based on the user sliding the content presentation page 210.

In some embodiments, the target virtual resource may further be determined based on historical behavior data of the current user. It should be understood that such historical behavior data is obtained and used in the scenario that the user is aware and permitted. As an example, the historical behavior data of the current user may include public data of the current user in the corresponding platform, for example.

In some embodiments, the electronic device 110 may present the object display interface 200C as shown in FIG. 2C in response to a user's triggering of the resource information 215. As an example, the electronic device 110 may present the resource information 215 and the plurality of objects 227 associated with the resource information 215 in the object display interface 200C. It may be understood that the plurality of objects 227 are all applicable to the target virtual resource corresponding to the resource information 215.

Based on the interaction process described above, the embodiments of the present disclosure can dynamically provide the resource information related to the related virtual resource according to the information of the object corresponding to the content presentation page, thereby improving the efficiency of obtaining the information by the user.

### Example Processes

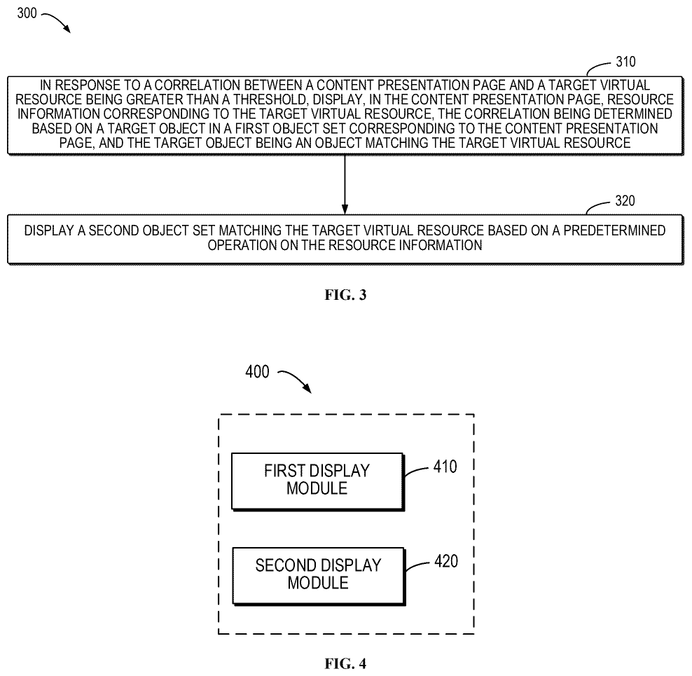

FIG. 3 illustrates a flowchart of an example interaction process 300 according to some embodiments of the present disclosure. Process 300 may be implemented at electronic device 110. The process 300 is described below with reference to FIG. 1.

As shown in FIG. 3, in block 310, the electronic device 110, in response to a correlation between a content presentation page and a target virtual resource being greater than a threshold, display, in the content presentation page, resource information corresponding to the target virtual resource, the correlation being determined based on a target object in a first object set corresponding to the content presentation page, and the target object being an object matching the target virtual resource.

At block 320, display a second object set matching the target virtual resource based on a predetermined operation on the resource information.

In some embodiments, the content presentation page is presented based on a received search request, and the target virtual resource is determined by: determining a category matching a query item comprised in the search request; determining a candidate virtual resource set corresponding to the category; and determining the target virtual resource from the candidate virtual resource set.

In some embodiments, determining the target virtual resource from the candidate virtual resource set comprises: determining the correlation between the content presentation page and the candidate virtual resource set; and determining the target virtual resource from the candidate virtual resource set whose correlation with the content presentation page is greater than the threshold.

In some embodiments, determining the target virtual resource from the candidate virtual resource set whose correlation with the content presentation page is greater than the threshold comprises: in response to correlations between the content presentation page and a plurality of candidate virtual resources being all greater than the threshold, determining, from the plurality of candidate virtual resources, the target virtual resource based on at least one attribute of the plurality of candidate virtual resources.

In some embodiments, the correlation is determined by: determining a number of objects in the first object set matching a corresponding virtual resource; and determining the correlation between the content presentation page and the corresponding virtual resource based on the number of objects in the first object set.

In some embodiments, the process 300 further comprises: determining whether the content presentation page comprises an object; and in response to the content presentation page comprising the object, determining whether the correlation between the content presentation page and the target virtual resource is greater than the threshold.

In some embodiments, displaying, in the content presentation page, resource information corresponding to the target virtual resource comprises: displaying the resource information at a target position in the content presentation page, the target position being determined based on a reference position of a reference object in the content presentation page, wherein the reference object comprises an object applicable to the target virtual resource or an object displayed at a predetermined position.

In some embodiments, a distance between the target position and the reference position is a predetermined distance; or a distance between the target position and the reference position is relevant to the target virtual resource.

In some embodiments, the process 300 further comprise: displaying, in the content presentation page, description information of at least one object, the description information indicating whether the at least one object matches the target virtual resource.

In some embodiments, the resource information comprise first resource information, and the process 300 further comprises: displaying, in the content presentation page, second resource information corresponding to a further virtual resource based on a predetermined operation on the content presentation page, wherein the predetermined operation comprises: a first operation for refreshing the content presentation page; or a second operation for sliding the content presentation page to view an additional search result.

In some embodiments, the target object comprises a commodity object, and the target virtual resource indicates a virtual benefit associated with the commodity object.

### Example Apparatus and Apparatus

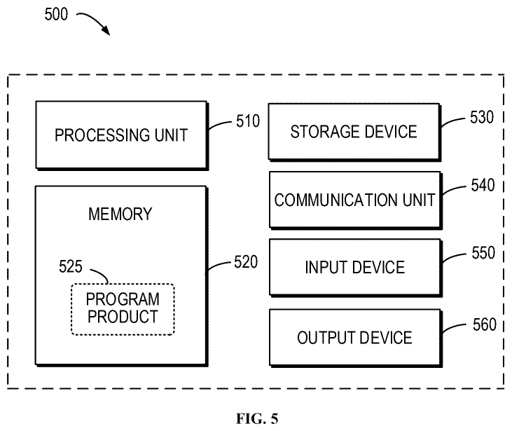

Embodiments of the present disclosure also provide a corresponding apparatus for implementing the above method or process. FIG. 4 illustrates a schematic structural block diagram of an example apparatus for interaction 400 according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the first display module 410 of the apparatus 400 is configured to, in response to a correlation between a content presentation page and a target virtual resource being greater than a threshold, display, in the content presentation page, resource information corresponding to the target virtual resource, the correlation being determined based on a target object in a first object set corresponding to the content presentation page, and the target object being an object matching the target virtual resource; and a second display module 420 configured to display a second object set matching the target virtual resource based on a predetermined operation on the resource information.

In some embodiments, the content presentation page is presented based on a received search request, and the target virtual resource is determined by: determining a category matching a query item comprised in the search request; determining a candidate virtual resource set corresponding to the category; and determining the target virtual resource from the candidate virtual resource set.

In some embodiments, determining the target virtual resource from the candidate virtual resource set comprises: determining the correlation between the content presentation page and the candidate virtual resource set; and determining the target virtual resource from the candidate virtual resource set whose correlation with the content presentation page is greater than the threshold.

In some embodiments, determining the target virtual resource from the candidate virtual resource set whose correlation with the content presentation page is greater than the threshold comprises: in response to correlations between the content presentation page and a plurality of candidate virtual resources being all greater than the threshold, determining, from the plurality of candidate virtual resources, the target virtual resource based on at least one attribute of the plurality of candidate virtual resources.

In some embodiments, the correlation is determined by: determining a number of objects in the first object set matching a corresponding virtual resource; and determining the correlation between the content presentation page and the corresponding virtual resource based on the number.

In some embodiments, the apparatus 400 further comprises an object determination module, configured to: determine whether the content presentation page comprises an object; and in response to the content presentation page comprising the object, determining whether the correlation between the content presentation page and the target virtual resource is greater than the threshold.

In some embodiments, the first display module 410 is further configured to display the resource information at a target position in the content presentation page, the target position being determined based on a reference position of a reference object in the content presentation page, wherein the reference object comprises an object applicable to the target virtual resource or an object displayed at a predetermined position.

In some embodiments, a distance between the target position and the reference position is a predetermined distance; or a distance between the target position and the reference position is relevant to the target virtual resource.

In some embodiments, the apparatus 400 further comprises a third display module configured to: display, in the content presentation page, description information of at least one object, the description information indicating whether the at least one object matches the target virtual resource.

In some embodiments, the resource information comprise first resource information, and the apparatus 400 further comprises a fourth display module, configured to: display, in the content presentation page, second resource information corresponding to a further virtual resource based on a predetermined operation on the content presentation page, wherein the predetermined operation comprises: a first operation for refreshing the content presentation page; or a second operation for sliding the content presentation page to view an additional search result.

In some embodiments, the target object comprises a commodity object, and the target virtual resource indicates a virtual benefit associated with the commodity object.

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 730, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions. Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

The invention claimed is:

1. An interaction method, comprising:
in response to a correlation between a content presentation page and a target virtual resource being greater than a threshold, displaying, in the content presentation page, resource information corresponding to the target virtual resource, the correlation being determined based on a target object in a first object set corresponding to the content presentation page, and the target object being an object matching the target virtual resource; and
displaying a second object set matching the target virtual resource based on a predetermined operation on the resource information.

2. The method of claim 1, wherein the content presentation page is presented based on a received search request, and the target virtual resource is determined by:
determining a category matching a query item comprised in the search request;
determining a candidate virtual resource set corresponding to the category; and
determining the target virtual resource from the candidate virtual resource set.

3. The method of claim 2, wherein determining the target virtual resource from the candidate virtual resource set comprises:
determining the correlation between the content presentation page and the candidate virtual resource set; and
determining the target virtual resource from the candidate virtual resource set whose correlation with the content presentation page is greater than the threshold.

4. The method of claim 3, wherein determining the target virtual resource from the candidate virtual resource set whose correlation with the content presentation page is greater than the threshold comprises:
in response to correlations between the content presentation page and a plurality of candidate virtual resources being all greater than the threshold, determining, from the plurality of candidate virtual resources, the target virtual resource based on at least one attribute of the plurality of candidate virtual resources.

5. The method of claim 1, wherein the correlation is determined by:
determining a number of objects in the first object set matching a corresponding virtual resource; and
determining the correlation between the content presentation page and the corresponding virtual resource based on the number of objects in the first object set.

6. The method of claim 1, further comprising:
determining whether the content presentation page comprises an object; and
in response to the content presentation page comprising the object, determining whether the correlation between the content presentation page and the target virtual resource is greater than the threshold.

7. The method of claim 1, wherein displaying, in the content presentation page, resource information corresponding to the target virtual resource comprises:
displaying the resource information at a target position in the content presentation page, the target position being determined based on a reference position of a reference object in the content presentation page,
wherein the reference object comprises an object applicable to the target virtual resource or an object displayed at a predetermined position.

8. The method of claim 7, wherein:
a distance between the target position and the reference position is a predetermined distance; or
a distance between the target position and the reference position is relevant to the target virtual resource.

9. The method of claim 1, further comprising:
displaying, in the content presentation page, description information of at least one object, the description information indicating whether the at least one object matches the target virtual resource.

10. The method of claim 1, wherein the resource information comprise first resource information, and the method further comprises:
displaying, in the content presentation page, second resource information corresponding to a further virtual resource based on a predetermined operation on the content presentation page, wherein the predetermined operation comprises: a first operation for refreshing the content presentation page; or a second operation for sliding the content presentation page to view an additional search result.

11. The method of claim 1, wherein the target object comprises a commodity object, and the target virtual resource indicates a virtual benefit associated with the commodity object.

12. An electronic device, comprising:
at least one processing unit; and
at least one memory coupled to the at least one processing unit and storing instructions for execution by the at least one processing unit, the instructions, when executed by the at least one processing unit, causing the electronic device to perform an interaction method comprising:
in response to a correlation between a content presentation page and a target virtual resource being greater than a threshold, displaying, in the content presentation page, resource information corresponding to the target virtual resource, the correlation being determined based on a target object in a first object set corresponding to the content presentation page, and the target object being an object matching the target virtual resource; and
displaying a second object set matching the target virtual resource based on a predetermined operation on the resource information.

13. The electronic device of claim 12, wherein the content presentation page is presented based on a received search request, and the target virtual resource is determined by:
determining a category matching a query item comprised in the search request;
determining a candidate virtual resource set corresponding to the category; and
determining the target virtual resource from the candidate virtual resource set.

14. The electronic device of claim 13, wherein determining the target virtual resource from the candidate virtual resource set comprises:
determining the correlation between the content presentation page and the candidate virtual resource set; and
determining the target virtual resource from the candidate virtual resource set whose correlation with the content presentation page is greater than the threshold.

15. The electronic device of claim 14, wherein determining the target virtual resource from the candidate virtual resource set whose correlation with the content presentation page is greater than the threshold comprises:
in response to correlations between the content presentation page and a plurality of candidate virtual resources being all greater than the threshold, determining, from the plurality of candidate virtual resources, the target virtual resource based on at least one attribute of the plurality of candidate virtual resources.

16. The electronic device of claim 12, wherein the correlation is determined by:
determining a number of objects in the first object set matching a corresponding virtual resource; and
determining the correlation between the content presentation page and the corresponding virtual resource based on the number of objects in the first object set.

17. The electronic device of claim 12, wherein the method further comprises:
determining whether the content presentation page comprises an object; and
in response to the content presentation page comprising the object, determining whether the correlation between the content presentation page and the target virtual resource is greater than the threshold.

18. The electronic device of claim 12, wherein displaying, in the content presentation page, resource information corresponding to the target virtual resource comprises:
displaying the resource information at a target position in the content presentation page, the target position being determined based on a reference position of a reference object in the content presentation page,
wherein the reference object comprises an object applicable to the target virtual resource or an object displayed at a predetermined position.

19. The electronic device of claim 18, wherein:
a distance between the target position and the reference position is a predetermined distance; or
a distance between the target position and the reference position is relevant to the target virtual resource.

20. A non-transitory computer-readable storage medium storing a computer program thereon, the computer program being executable by a processor to implement an interaction method comprising:
in response to a correlation between a content presentation page and a target virtual resource being greater than a threshold, displaying, in the content presentation page, resource information corresponding to the target virtual resource, the correlation being determined based on a target object in a first object set corresponding to the content presentation page, and the target object being an object matching the target virtual resource; and
displaying a second object set matching the target virtual resource based on a predetermined operation on the resource information.
